(19) United States
(12) Patent Application Publication
(10) Pub. No.: US 2005/0213553 A1
(43) Pub. Date: Sep. 29, 2005

(54) Method for wireless LAN intrusion detection based on protocol anomaly analysis

(76) Inventor: Huayan Amy Wang, Hauppauge, NY (US)

Correspondence Address: BAKER & BOTTS, 30 ROCKEFELLER PLAZA, NEW YORK, NY, 10112, US

(21) Appl. No.: 10/809,599

(22) Filed: Mar. 25, 2004

(51) Int. Cl. H04L 12/56

(52) U.S. Cl. 370/349

(57) ABSTRACT

Unauthorized use of a wireless local area network is detected, wherein the network includes mobile units that communicate with at least one server computer through access points. The messages transmitted over the wireless local area network are analyzed for compliance with rules set out in the specification for the selected wireless local area network protocol. If an inconsistency is detected, an alarm is generated to indicate a possible intruder access attempt to the wireless local area network.

### BACKGROUND OF INVENTION

The present invention relates to wireless local area networks (WLANs). In particular the invention relates to methods for detecting unauthorized access or attempted access to a wireless local area network and for preventing attacks on the wireless network (such as denial of service attacks).

The tretmendous success of WLAN has made it a popular target of hackers (known as “whackers”) who are actively developing new methods for attacking and intruding WLANs. New WLAN hacking tools are published on the internet at an alarming rate. Many industry surveys show that WLAN security is the top concern for most corporate Chief Information Officers considering WLAN deployment. Unfortunately, contemporary WLAN security solutions are either flawed or unproven.

In co-pending application Ser. No. 09/528,697, filed Mar. 17, 2000, which is owned by the assignee of the present application and incorporated herein by reference, there is described a system which follows the protocol of IEEE Standard 802.11, but which uses a combination of RF Ports (also called “access ports”) and Cell Controllers to perform the functions of Access Points of a classical 802.11 data communications system. Lower level MAC functions are performed by the RF Ports and higher level MAC functions, including association and roaming functions, are performed by the cell controller. The term “access point” as used herein is intended to include conventional access points, such as those which follow the protocol of IEEE Standard 802.11 and perform all MAC functions, as well as RF Ports operating with cell controllers, as described in the incorporated co-pending application.

In co-pending application Ser. No. 10/744,026, filed Dec. 22, 2003, which is owned by the assignee of the present application and incorporated herein by reference, there is described a method for use in a wireless local area data communications system, wherein mobile units communicate with access points, and wherein the system is arranged to locate transmitters using signals transmitted by the transmitters. A database relating authorized transmitters to location is maintained in a server. Selected signals are detected at the access points and location data corresponding to the selected signals for use in locating a source of the signals is recorded. The source is located using the location data, and the source location is compared to a corresponding location in the database. An alarm is signaled if the source location is inconsistent with the corresponding database location.

While the above system and method may provide one effective means for identifying intruders on a WLAN, it would be advantageous to provide even greater security by additional means.

Additionally, current security measures such as Wired Equivalent Privacy (WEP) protocol specified in the IEEE 802.11b standard have recently been reported to be flawed. A research group from the University of California at Berkeley recently published a report citing “major security flaws” in WEP that left WLANs using the protocol vulnerable to wireless equivalent privacy attacks. In the course of the group's examination of the technology, they were able to intercept and modify transmissions and gain access to restricted networks. Thus, an improved security system which overcomes some of the flaws of WEP is needed.

Intrusion Detection Systems (IDS) are the computer equivalent of burglar alarms—they monitor computer networks to detect security comprises and policy violations. They have long been used to monitor Network traffic (NIDS) and Host computers (HIDS), utilizing well-established techniques such as signature-based or anomaly-based analysis to detect intrusions.

Anomaly-based techniques can be further classified into two categories—protocol anomaly and traffic anomaly analyses. Protocol anomaly systems attempt to identify protocol misusage, i.e., any use outside of the official or practical usage of a particular protocol. It would be advantageous to provide a system and method for protocol anomaly detection for wireless network protocols such as the IEEE 802.11 protocol, to detect and prevent attacks such as those exploiting known WEP vulnerabilities, utilizing anomalous MAC header/trailer data, and transmitting illegal packets (e.g., probe requests with null SSID which may cause some 802.11 access points to crash).

Accordingly, it is an object of the present invention to provide an improved method for detecting unauthorized access or attempted access to a WLAN by using protocol anomaly analysis and further to provide an improved method for preventing attacks on the wireless network (such as denial of service attacks).

### SUMMARY OF THE INVENTION

In accordance with the invention there is provided a system and method for use in a wireless data communications system wherein mobile units communicate with a computer using access points, and wherein the system operates according to a protocol specifying a format for data message packets, for detecting unauthorized access attempts to the system, which includes the steps of forwarding data packets received by the access points to a computer and operating the computer to compare the format of the received data packets to selected requirements of the protocol-specified format, and signaling an alert if the packets deviate from the specified format.

For a better understanding of the present invention, together with other and further objects thereof, reference is made to the following description, taken in conjunction with the accompanying drawings, and its scope will be pointed out in the appended claims.

### BRIEF DESCRIPTION OF THE DRAWINGS

FIG. 1 is a block diagram illustrating a wireless local area network in which the method of the present invention may be practiced;

FIG. 2 is a block diagram illustrating a wireless local area network in which the method of the present invention may be practiced;

FIG. 3 is a block diagram illustrating a wireless local area network in which the method of the present invention may be practiced.

Throughout the Figures the same reference numerals and characters, unless otherwise stated, are used to denote like features, elements, components or portions of the illustrated embodiments. Moreover, while the present invention will now be described in detail with reference to the Figures, it is done so in connection with the illustrative embodiments.

### DESCRIPTION OF THE INVENTION

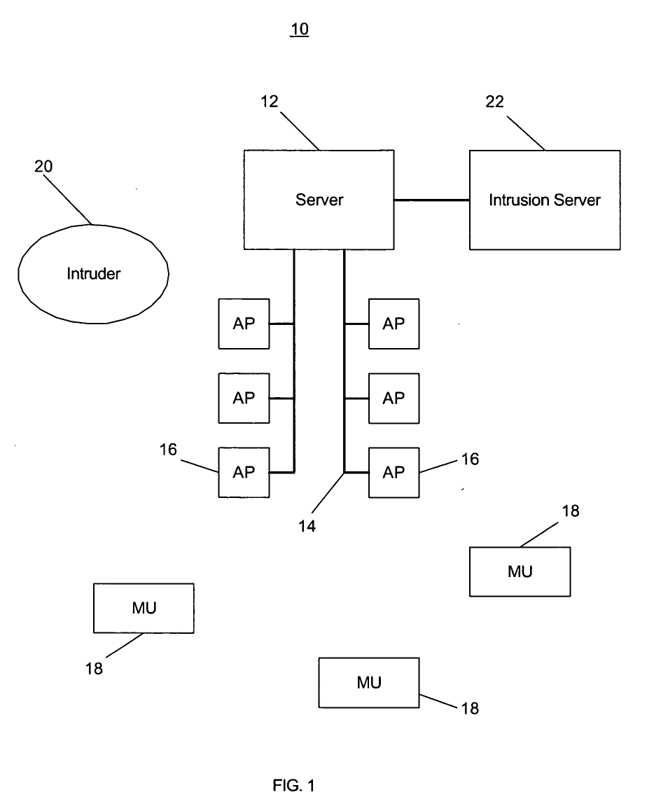

Referring to FIG. 1 there is shown a wireless local area network 10 having a server 12 connected over a wired network 14 to a plurality of access points 16. Network 10 may operate according to a standard protocol, such as IEEE Standard 802.11 to provide wireless network data communications between mobile units 18 and server 12. IEEE Standard 802.11 is fully incorporated herein by reference, and would further be known to one of ordinary skill in the art.

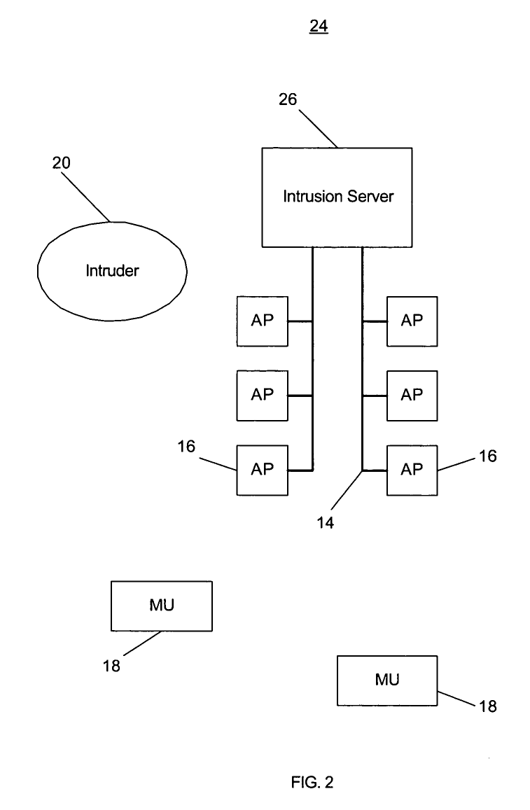

In an exemplary embodiment of the present invention, messages received by the access points of the system, including messages from sources other than mobile units associated with the access point, are forwarded to server 12 for analysis. Server 12 provides the messages or data derived from the messages, to intrusion server 22. Server 12 may be a network server, a central switch, or some other component which bridges the wireless network to a wired network or to intrusion server 22. Alternatively, data may be forwarded directly to intrusion server 22 from the wireless network components, thus alleviating the need for server 12 (as shown in FIG. 2, in which intrusion server 26 receives data directly from wireless access points or switches). The data may include details regarding messages transmitted and received by access points 16 and mobile units 18. Intrusion server 22 may contain at least a processor and a memory, such that it may process the data received from server 12 to perform intrusion detection analysis. Accordingly, intrusion server 22 may be a typical network computer server, a standalone personal computer, or any other device which is capable of performing the processing necessary for the functions described herein. In accordance with the invention the server 12 may perform the intrusion server functions by inclusion of appropriate intrusion server programming.

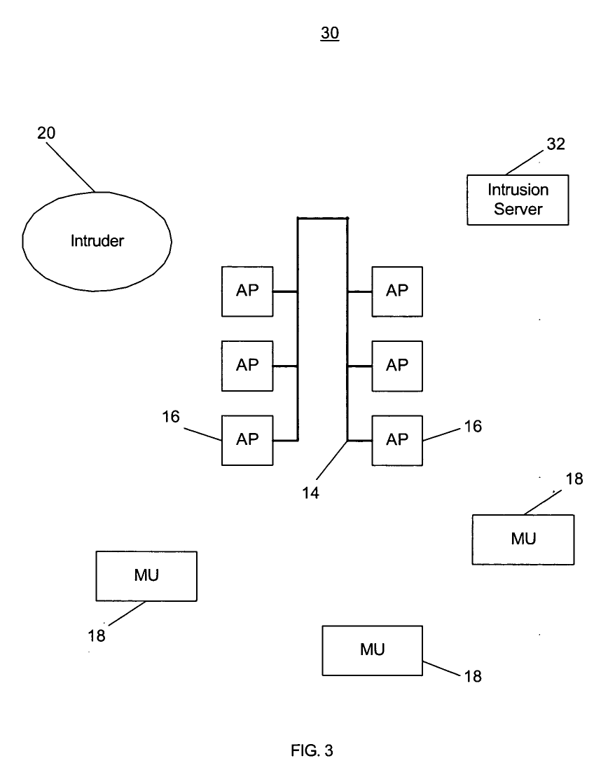

Referring to FIG. 3, in another exemplary embodiment of the present invention, intrusion server 32 may be configured with a RF apparatus such that it can directly access information on the wireless network. Intrusion server 32 may be configured to actively monitor and capture signals transmitted on the WLAN for further analysis.

In a preferred embodiment of the present invention, the IDS analysis performed by intrusion server 22 relates to protocol anomaly detection. One of ordinary skill in the art will understand that the scope of the present invention is not limited in the type of analysis performed. For example, in the case of an 802.11b wireless local area network, the intrusion server 22 may perform IDS analysis in accordance with the IEEE 802.11 standard specification. Some exemplary details of this analysis are now discussed in greater detail. It is noted that, in the following exemplary embodiments of the present invention, the analysis described are preferably performed by the intrusion detection server 22 using intrusion detection software/firmware. However, one of ordinary skill in the art would recognize that these analyses may be performed by any number of different elements connected to the network, including, e.g., a handheld terminal or remote terminal, and that such further embodiments are within the scope of the invention described herein.

In a first exemplary embodiment of a system and method in accordance with the present invention, the intrusion server 22 may be used to detect anomalies which are inconsistent with the 802.11 protocol.

As defined more fully in the 802.11 protocol specification, 802.11 MAC frames are structured as shown in Table 1:

TABLE 1
802.11 MAC Frame Format

| Frame | Duration | | | | Sequence | | Frame | |
|---|---|---|---|---|---|---|---|---|
| Control | ID | Addr 1 | Addr 2 | Addr 3 | Control | Addr 4 | Body | CRC |
| 2 Bytes | 2 Bytes | 6 Bytes | 6 Bytes | 6 Bytes | 2 Bytes | 6 Bytes | 0-2312 | 4 Bytes |
| | | | | | | | Bytes | |

| | | |
|---|---|---|
| 802.11 MAC Header | Body | CRC |

802.11 MAC frame formats differ depending on frame type (i.e., Control Frames, Management Frames, and Data Frames), which is determined by the value of the Frame Control field. The Frame Control field (the first two bytes of the MAC header) is structured generally as shown in Table 2:

TABLE 2
802.11 MAC Frame Control Field Format

| Protocol | | | | From | More | | Power | More | | |
|---|---|---|---|---|---|---|---|---|---|---|
| Version | Type | Sub Type | To DS | DS | Frag. | Retry | Mgmt | Data | WEP | Rsvd |
| 2 Bits | 2 Bits | 4 Bits | 1 Bit | 1 Bit | 1 Bit | 1 Bit | 1 Bit | 1 Bit | 1 Bit | 1 Bit |

In this exemplary embodiment of the present invention, the 802.11 MAC header and specifically the Frame Control field can be used to detect network intrusions.

In various exemplary embodiments of systems and methods according to the present invention, numerous different aspects of the 802.11 protocol may be checked for compliance. For example, an intrusion may be detected where the WEP flag of the Frame Control field is not set for a WEP session, or where the WEP flag is set in a non-WEP session. This can be determined by extracting the source MAC address and performing a lookup in a state table (discussed below) to compare the current session information with the WEP flag of the Frame Control field. If an inconsistency is detected, an alarm may then be generated to indicate a possible network intrusion attempt.

In this and other embodiments of the present invention, a state table may be implemented in several different ways to track selected variables and detect attempted intrusion scenarios. In accordance with the present invention, Stateful WIDS, wherein the intrusion server can perform checks based on state information, requires that the intrusion server extract state information from the packets it captures and maintain a state transition history of each wireless device on the WLAN. Certain intrusions can be detected by monitoring this state transition information, which may be stored in the form of a state table. The state table may preferably include a list of recently active MAC addresses and their associated state information. Though the present invention is not limited to such embodiments, the state information stored in a state table may include some or all of the following information (as defined in the 802.11 protocol standard): MAC address, Device type, Vendor, Protocol version, Current State Status, WEP_Security_Setting (Authentication, Encryption, Multicast/broadcast data encryption), Power management mode, Fragmentation threshold, RTS threshold, Last_pkts[N] (store the last N packets with for a particular source MAC address, with information such as Time stamp, location info, channel, signal quality), and various Traffic Statistics, AP statistics, and Switch statistics. It is noted that the implementation of a state table in accordance with the present invention is not limited to the implementation above, or to the 802.11 protocol—such a state table may generally be implemented in accordance with the invention to store any important variables which pertain to the wireless units on a WLAN such that packets received in the future may checked against values stored in the state table to detect intrusions and to update the state table as necessary.

In another example, an intrusion may be detected where the Protocol Version field of the Frame Control field is suspicious. Again, the source MAC address can be extracted and a lookup performed in a state table, implemented as described above, to compare the protocol version with that in the Frame Control field. If an inconsistency is detected, an alert may be generated to indicate a possible intrusion attempt. Likewise, the source MAC address may be extracted may be checked for any suspicious settings—e.g., where the source MAC address is a multicast/broadcast address. An alarm may be similarly triggered in such situations.

Similarly, where the Power Mgmt state in a message differs from that in the State Table, this may in some instances indicate suspicious activity—e.g., a denial-of-service (DoS) attack launched on a mobile unit. For example, a hacker may inject a data packet with a spoofed victim mobile unit MAC address and set the Power Mgmt field to 1, thus causing the victim mobile unit to miss all data packets. Under such circumstances an alarm signal may be triggered.

In another potential DoS attack situation, a hacker may target the power save mode of a mobile unit to consume power. A hacker may inject a data packet with a spoofed victim MAC address and set More Data field to 1 so that the victim mobile unit cannot enter sleep mode. This situation can be detected, e.g., by checking the More Data field of the Frame Control field. If the More Data bit is set to 1, the session info can be logged. Thereafter, if no reply is received to a ps_poll message, an alarm signal may be generated.

In another example, the Type and Sub Type bits of the Frame Control field can be checked for illegal or unsupported values. Where an inconsistency is detected, an alarm is generated.

In yet another example, the To DS and From DS bits of the Frame Control field may be checked for consistency with respect to the address fields (Addr 1, Addr 2, Addr 3, Addr 4). The 802.11 standard sets out rules regarding whether corresponding addresses should be stations or APs. Where those rules are violated, a possible intruder scenario may be detected, and an alarm can accordingly be generated.

Further still, an unauthorized MAC address may be identified by extracting the address fields (Addr 1, Addr 2, Addr 3, Addr 4) and comparing them to a list of legal devices. If an illegal MAC address is detected it may be the result of a “spoofed” MAC address created by a hacker attempting to gain access to the network. Accordingly, an alarm may then be generated.

Similarly, the Duration ID field of the MAC header may be checked to detect a possible intrusion. For example, if the duration differs significantly from the required duration as defined in the 802.11 specification, or if the duration is substantially greater than the frame length (an excessively long duration), an alert may be generated. This check can be performed in numerous ways, including utilizing the IDS keep state to perform the calculation, or checking the direct data frame Duration against its frame length).

Additionally, intrusion scenarios may be detected by analyzing other portions of the data packets. For example, the MAC trailer may be analyzed for potential DoS attacks which would likely indicate hacking activities. For example, where excessive numbers of Frame Check Sequence (FCS) failures are received, an alarm may be generated. This may be detected by updating the FCS failure rate per MAC upon receipt of each packet. If the FCS failure rate becomes greater than some preset threshold (in, e.g., failures per minute), an alert may be generated.

Other general 802.11 protocol anomalies may be detected using the system and method of the present invention. For example, where an illegal frame size is received, as compared with the allowable frame sizes set forth in the 802.11 protocol specification, a possible intrusion system may be detected (for example, where a data frame is less than 34 Bytes or greater than 2,346 Bytes, where a management frame is less than 28 Bytes or greater than 2,340 Bytes, etc.)

Further, if a frame contains an SSID (beacon, association request, reassociation request, probes) or SSID element in an information element, the SSID can be checked against a list of default or weak SSIDs. If a default or weak SSID is detected, this may be the result of a hacker crafting a probe request with the default SSID to test the security settings of the network. This may be identified as suspicious activity such that an alarm signal may be generated.

In a next exemplary embodiment of a system and method in accordance with the present invention, the intrusion server 22 may be used to detect protocol anomalies which relate to known WEP vulnerabilities.

In one such embodiment, the system and method of the present invention may analyze the WEP authentication Initialization Vector (IV) to identify potential network intrusions. For example, in a potential attack against one of the known WEP flaws, a hacker may reuse a previous IV. To detect this situation, the system and method of the present invention may store the most recent N number of IVs used in WEP authentication or in WEP traffic (after reassembly). If a previous IV is reused, an alarm may be generated indicating a potential network intrusion.

Furthermore, where excessive failed Integrity Check Values (ICV) are calculated per MAC or AP/switch, an alarm may be generated to indicate a possible intrusion scenario. To detect such excessive failures, a statistical analysis may be performed to determine what range of failure rates occur during “normal” or authorized network access conditions. If the number of failures exceeds the threshold, an alarm may be generated. Similarly, where excessive TCP failures per MAC or AP/switch are detected, a like analysis and comparison can be performed to identify potential intrusions.

In yet another exemplary embodiment of the present invention, 802.11 Management Frames may be analyzed to detect potential intrusion scenarios.

In one such scenario, an illegal probe response may indicate an intrusion scenario. An illegal Probe Response may be one in which the Probe Response Source MAC is not an AP. In an embodiment of the present invention, Probe Responses may be analyzed and an alarm may be generated. Similarly, illegal association frames may be received, indicating a possible intruder scenario. This may occur where an Associate Request is received from an AP. or where an Association Response is received from a non-AP. In such event, an alarm may be triggered.

Likewise, illegal authentication frames may indicate network tampering. Authentication sequences may be analyzed to detect such illegal frames, which may be categorizes as one containing, e.g., an unsupported algorithm number, a wrong authentication sequence number in the sequence (as defined in the 802.11 standard), an unsupported status code, or a wrong DA/SA in the sequence. If any of the above is detected, an alarm may be triggered to indicate a possible WLAN intrusion scenario.

In still another exemplary embodiment of the present invention, 802.11 Control Frames may be analyzed to detect potential intrusion scenarios. For example, excessive CTS or RTS per MAC/AP/Switch may indicate a potential intrusion attempt. A statistical analysis and threshold comparison may be performed to identify such intrusion scenarios.

In a similar scenario, where a CTS is received without a companion RTS, another intrusion scenario may be occurring. In one embodiment of a wireless LAN, APs may forward all RTS and CTS packets (with timestamps) to the switch. In such a configuration, the intrusion detection server of the present invention may be used to track RTS/CTS pairs. Where a CTS is received without an RTS, or such occurs more than a predetermined threshold number of times, an alarm may be generated. In another scenario, the intrusion detection server may be configured to detect an illegal RTS (where the RTS is too small for the particular packet size). The intrusion detection server may also be used to detect control frames with a multicast destination MAC address. In any of these events, a potential intrusion scenario may be occurring, and accordingly an appropriate alarm may be generated.

It is noted that various embodiments of the present invention may be formulated to detect the various described protocol anomaly situations either alone (i.e., only scanning for a single type of protocol anomaly) or in combination (scanning for multiple different types of the protocol anomalies described herein as well as those that would be known to one of ordinary skill in the art). Furthermore, various threshold settings may be established to determine whether each of the particular situations is suspicious enough to warrant triggering of an alarm. Such considerations would be largely dependent upon the particulars of the WLAN implementation.

It is further noted that, while the examplary embodiments described herein relate to the IEEE 802.11 network protocol, one of ordinary skill in the art would understand that the principles herein can be applied to any other wireless local area network protocol, and that the scope of the present invention is not limited to the embodiments described here.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. In a wireless data communications system wherein mobile units communicate with a computer using access points, and wherein said system operates according to a protocol specifying a format for data message packets, a method for detecting unauthorized access attempts to the system, comprising:
forwarding one or more data packets received by said access points to a computer; and
operating said computer to compare format of said one or more received data packets to selected requirements of said protocol-specified format, and signaling an alert if said packets deviate from said protocol-specified format.

2. A method as specified in claim 1 wherein said protocol-specified format includes a header message portion and wherein said comparing of format comprises comparing format of said header message portion to said protocol-specified format.

3. A method as specified in claim 2 wherein said protocol is IEEE Standard 802.11.

4. A method as specified in claim 2 wherein said protocol is IEEE Standard 802.11 having a frame control field in said header message portion and wherein said comparing of format comprises comparing format of said frame control field.

5. A method as specified in claim 1 wherein said protocol is IEEE Standard 802.11, and further wherein said one or more received data packets comprise IEEE Standard 802.11 Management Frames.

6. A method as specified in claim 1 wherein said protocol is IEEE Standard 802.11, and further wherein said one or more received data packets comprise IEEE Standard 802.11 Control Frames.

7. A method as specified in claim 1 wherein said protocol is IEEE Standard 802.11, and further wherein said one or more received data packets comprise a first WEP flag.

8. A method as specified in claim 7 wherein said packets have a first WEP flag value which is inconsistent with a second WEP value stored in a state table on said computer.

9. A method as specified in claim 1 wherein said one or more received data packets comprise a first Protocol Version value which is inconsistent with a second Protocol Version value stored in a state table on said computer.

10. A method as specified in claim 1 wherein said one or more received data packets comprise a source MAC address which is a multicast address.

11. A method as specified in claim 1 wherein said one or more received data packets comprise a source MAC address which is a broadcast address.

12. A method as specified in claim 3 wherein said one or more received data packets comprise a first Power Management state variable which is inconsistent with a second Power Management state variable value stored in a state table on said computer.

13. A method as specified in claim 3 wherein the step of operating said computer further comprises checking a More Data field of said received data packets and further monitoring said access points for a possible denial of service attack.

14. A method as specified in claim 3 wherein said one or more received data packets comprise an unsupported Type value.

15. A method as specified in claim 3 wherein said one or more received data packets comprise an unsupported SubType value.

16. A method as specified in claim 1 wherein said one or more received data packets comprise a spoofed MAC address.

17. A method as specified in claim 3 wherein said one or more received data packets comprise a frame of length which is inconsistent with said protocol-specified format.

18. A method as specified in claim 1 further comprising the step of maintaining a state table in said computer.

19. In a wireless data communications system wherein mobile units communicate with a computer using access points, and wherein said system operates according to a protocol specifying a format for data message packets, a method for detecting unauthorized access attempts to the system, comprising:
forwarding one or more data packets received by said mobile units to a computer; and
operating said computer to compare format of said one or more received data packets to selected requirements of said protocol-specified format, and signaling an alert if said packets deviate from said protocol-specified format.

20. A method as specified in claim 19 wherein said protocol-specified format includes a header message portion and wherein said comparing of format comprises comparing format of said header message portion to said protocol-specified format.

21. A method as specified in claim 20 wherein said protocol is IEEE Standard 802.11 having a frame control field in said header message portion and wherein said comparing of format comprises comparing format of said frame control field.

22. A method as specified in claim 19 wherein said protocol is IEEE Standard 802.11, and further wherein said one or more received data packets comprise IEEE Standard 802.11 Management Frames.

23. A method as specified in claim 18 wherein said protocol is IEEE Standard 802.11, and further wherein said one or more received data packets comprise IEEE Standard 802.11 Control Frames.

24. A method as specified in claim 19 wherein said protocol is IEEE Standard 802.11.

25. A method as specified in claim 19 wherein said protocol is IEEE Standard 802.11, and further wherein said one or more received data packets comprise a first WEP flag.

26. A method as specified in claim 25 wherein said packets have a first WEP flag value which is inconsistent with a second WEP value stored in a state table on said computer.

27. A method as specified in claim 25 wherein said one or more received data packets comprise a first Protocol Version value which is inconsistent with a second Protocol Version value stored in a state table on said computer.

28. A method as specified in claim 24 wherein said one or more received data packets comprise a source MAC address which is a multicast address.

29. A method as specified in claim 24 wherein said one or more received data packets comprise a source MAC address which is a broadcast address.

30. A method as specified in claim 24 wherein said one or more received data packets comprise a first Power Management state variable which is inconsistent with a second Power Management state variable value stored in a state table on said computer.

31. A method as specified in claim 24 wherein the step of operating said computer further comprises checking a More Data field of said received data packets and further monitoring said access points for a possible denial of service attack.

32. A method as specified in claim 24 wherein said one or more received data packets comprise an unsupported Type value.

33. A method as specified in claim 24 wherein said one or more received data packets comprise an unsupported SubType value.

34. A method as specified in claim 24 wherein said one or more received data packets comprise a spoofed MAC address.

35. A method as specified in claim 24 wherein said one or more received data packets comprise a frame of length which is inconsistent with said protocol-specified format.

36. A method as specified in claim 1 further comprising the step of maintaining a state table in said computer.

37. In a wireless data communications system wherein mobile units communicate with a computer using access points, and wherein said system operates according to a protocol specifying a format for data message packets, a method for detecting unauthorized access attempts to the system, comprising:
forwarding one or more data packets received by said mobile units to a computer; and
operating said computer to compare selected portions of said one or more received data packets to values stored in a state table in accordance with a specified protocol, and signaling an alert if said selected portions of said one or more packets deviate from said values stored in said state table.

38. A method as specified in claim 37 wherein said specified protocol is IEEE Standard 802.11.

39. A method as specified in claim 37 further comprising the step of maintaining a state table in said computer.
